(19) United States
(12) Patent Application Publication
(10) Pub. No.: US 2014/0210968 A1
(43) Pub. Date: Jul. 31, 2014

(54) MOBILE TEST READER APPARATUS

(71) Applicant: iStoc Oy, Oulunsalo (FI)

(72) Inventors: Hannu KAUNISKANGAS, Oulunsalo (FI); Jarmo JARVENPAA, Oulunsalo (FI)

(73) Assignee: iStoc Oy, Oulunsalo (FI)

(21) Appl. No.: 14/165,953

(22) Filed: Jan. 28, 2014

(30) Foreign Application Priority Data
Jan. 31, 2013 (FI) 20135093

(51) Int. Cl. H04N 1/00

(52) U.S. Cl. CPC H04N 1/00328
USPC 348/61

(57) ABSTRACT

Mobile test reader is disclosed. Reader receives, with wireless transceiver, test-specific plug-in from external entity, configures test reader application with plug-in, and takes, with digital camera controlled by application configured with plug-in, image data depicting output area of test. Furthermore, reader, under control of application configured with plug-in, performs at least one of following: transmits, with transceiver, image data to external entity; generates, with application configured with plug-in, test result for test on the basis of image data; transmits, with transceiver, test result to external entity; outputs, with user interface, test result.

### FIELD

The invention relates to a mobile test reader apparatus.

### BACKGROUND

Tests such as lateral flow tests are read with manufacturer-specific readers, but more generic apparatuses are currently emerging, one example being described in WO 2012/131386.

### BRIEF DESCRIPTION

The present invention seeks to provide an improved mobile test reader apparatus.

According to an aspect of the present invention, there is provided a mobile test reader apparatus comprising a digital camera, a wireless transceiver, a user interface, one or more processors, and one or more memories including computer program code, the one or more memories and the computer program code configured to, with the one or more processors, cause the mobile test reader apparatus at least to perform: receive, with the wireless transceiver, a test-specific plug-in from an external entity; configure a test reader application with the test-specific plug-in; and take, with the digital camera controlled by the test reader application configured with the test-specific plug-in, image data depicting an output area of a test; and, the one or more memories and the computer program code are further configured to, with the one or more processors, under the control of the test reader application configured with the test-specific plug-in, cause the mobile test reader apparatus further to perform at least one of the following: transmit, with the wireless transceiver, the image data to an external entity; generate, with the test reader application configured with the test-specific plug-in, a test result for the test on the basis of the image data; transmit, with the wireless transceiver, the test result to an external entity; output, with the user interface, the test result.

According to another aspect of the present invention, there is provided a computer-readable non-transitory medium comprising computer program code of a test reader application and a test-specific plug-in, which computer program code, when executed on a mobile test reader apparatus, causes the mobile test reader apparatus to: receive, with a wireless transceiver, a test-specific plug-in from an external entity; configure a test reader application with the test-specific plug-in; and take, with a digital camera controlled by the test reader application configured with the test-specific plug-in, image data depicting an output area of a test; and at least one of the following: transmit, with the wireless transceiver, the image data to an external entity; generate, with the test reader application configured with the test-specific plug-in, a test result for the test on the basis of the image data; transmit, with the wireless transceiver, the test result to an external entity; output, with the user interface, the test result.

### LIST OF DRAWINGS

Example embodiments of the present invention are described below, by way of example only, with reference to the accompanying drawings, in which

FIG. 1 illustrates an example embodiment of a general operating environment;

FIG. 2 illustrates example embodiments of a test;

FIG. 3 illustrates example embodiments of an external entity; and

FIGS. 4, 5, 6 and 7 illustrate example embodiments of a mobile test reader.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments of apparatuses, they are simplified block diagrams that only show some structures and functional entities. The connections shown in these Figures are logical connections; the actual physical connections may be different. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses may also comprise other functions and structures. It should be appreciated that details of some functions, structures, and the protocols used for communication are irrelevant to the actual invention. Therefore, they need not be discussed in more detail here. Although the apparatuses have been depicted as separate single entities, different parts may be implemented in one or more physical or logical entities.

FIG. 1 illustrates an example embodiment of a general operating environment. A mobile test reader 100 takes an image 106 of a test 102. Furthermore, the mobile test reader 100 communicates data 108 relating to the test 102 with an external entity 104.

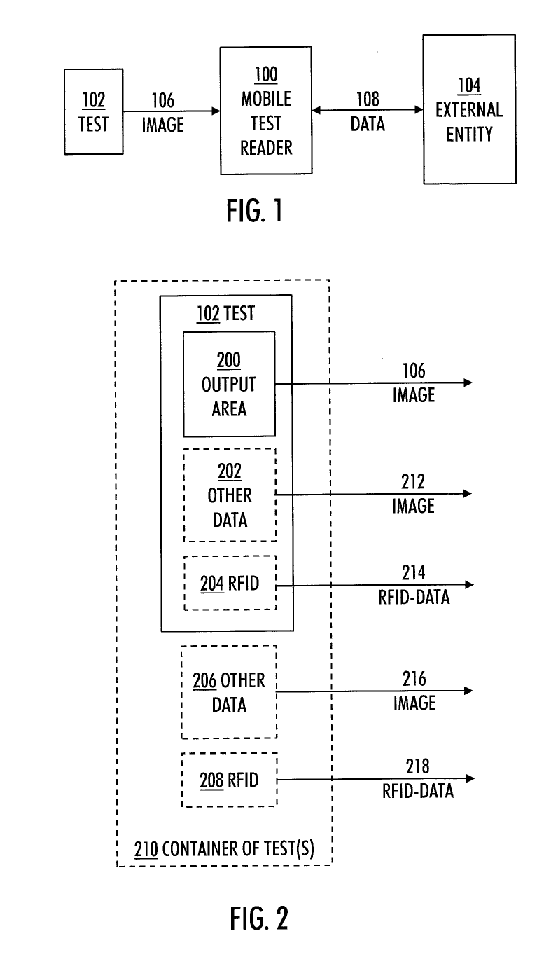

FIG. 2 illustrates example embodiments of the test 102. The test 102 is capable of measuring a certain property of a target analyte in a sample. In its simplest form, the test 102 is capable of detecting the presence (or absence) of the target analyte in the sample. As the test 102 is relatively simple and cheap, it may be used for various diagnostics at home or in the field, for example, but also in clinics and laboratories.

The test 102 may be applied to human or animal secretions such as urine, saliva, blood, or stool samples, or also to other substances such as food or water. Accordingly, the test 102 may be utilized for medical testing of humans or animals, or testing food and water for contaminants, for example.

In an example embodiment, the test 102 is a (clinical) point of care test for pregnancy, fertility, HIV, coronary artery disease, malaria, drug abuse, respiratory disease, or for some other medical condition.

In an example embodiment, the test 102 may be a lateral flow test (also known as a lateral flow immunochromatographic assay).

The test 102 comprises an output area 200 whose visual appearance changes to show the result of the test 102 in the form of the image 106. In the lateral flow test 102, the output area 200 may comprise at least one stripe, coupled by at least one capillary bed to a conjugate, the stripe changing colour as a result of a specified chemical reaction between a target molecule in the sample and its chemical partner in the conjugate.

In an example embodiment, the structure of the test 102 may also be hierarchical, meaning that it may include more than one parallel tests, and even that one or more of the parallel tests may in turn include a number of subtests.

In an example embodiment, besides being the lateral flow test, the test 102 may be any test of at least one such chemical property that affects the visual appearance of the output area 200.

In an example embodiment, the test 102 may also comprise, besides the output area 102, other data 202 that may be visually inspected in the form of an image 212.

In an example embodiment, the test 102 may also comprise a radio frequency identifier (RFID) tag 204 capable of storing data that may be read 214 wirelessly.

In an example embodiment, a container 210 of the test 102 may comprise other data 206 that may be visually inspected in the form of an image 216, and/or a radio frequency identifier tag 208 capable of storing data that may be read 218 wirelessly. The container 210 may contain only one test 102 or a specific number of tests 102.

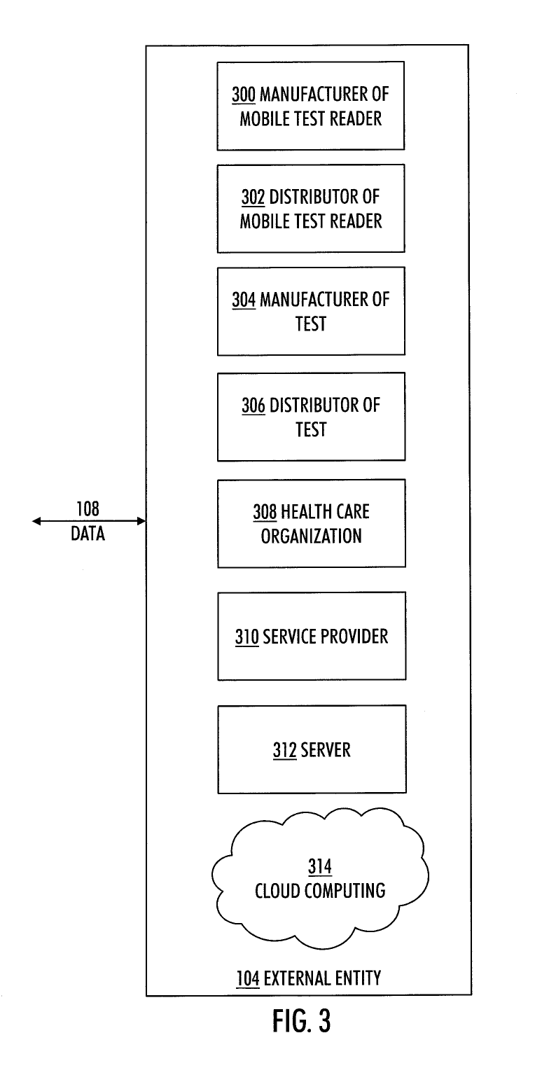

FIG. 3 illustrates example embodiments of the external entity 104. The term “external entity” 104 refers to any interest group having a legitimate interest in the use of the test 102 and/or to any technical counterpart of the mobile test reader 100. Accordingly, a non-exhaustive list of the external entity 104 comprises at least one of the following: a manufacturer 300 of the mobile test reader 100, a distributor 302 of the mobile test reader 100, a manufacturer 304 of the test 102, a distributor 306 of the test 102, a health-care organization 308, a service provider 310, a server 312, a cloud computing 314. Naturally, the desired operating environment determines the rights of the various interest groups and the properties of the selected technical counterparts.

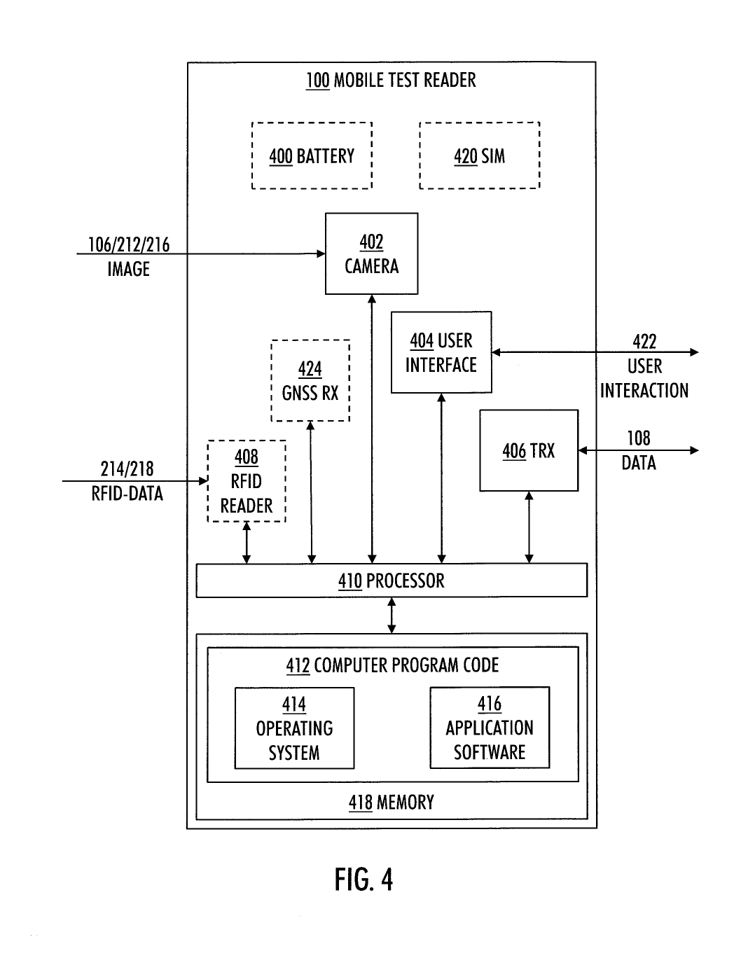

FIG. 4 illustrates some example embodiments of the mobile test reader 100. The mobile test reader 100 may be any suitable mobile electronic apparatus. A non-exhaustive list of the types of the apparatus 100 includes: a mobile phone, a smartphone, a tablet computer, a general-purpose mobile computing device. In an example embodiment, the mobile test reader 100 is a general-purpose off-the-shelf computing device, as opposed to a purpose-build proprietary test reader, whereby research & development costs will be lower as only the special-purpose software (and not the hardware) needs to be designed, implemented and tested.

The mobile test reader 100 may comprise a battery 400, a digital camera 402, a user interface 404, a wireless transceiver 406, and a radio-frequency identifier reader 408.

In an example embodiment, the (rechargeable) electrical battery 400 is one or more electrochemical cells that convert stored chemical energy into electrical energy. Instead of battery 400, other suitable accumulator means may be used to store energy.

In an example embodiment, the digital camera 402 takes video or still photographs by recording images on an electronic image sensor through an optical system.

In an example embodiment, the user interface 404 implements the exchange 422 of graphical, textual and auditory information with the user of the mobile test reader 100. The user interface 404 may be realized with various techniques, such as a display, means for producing sound, a keyboard, and/or a keypad, for example. The display may be a liquid crystal display, for example, but it may also be implemented by any appropriate technique, such as with an active-matrix organic light-emitting diode. The display may also incorporate other user interaction means, such as touch input, or haptic feedback, i.e. the display may be a touch screen. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, the user interface 404 may comprise other user interface components, for example various means for focusing a cursor (mouse, track ball, arrow keys, touch sensitive area etc.) or elements enabling audio control.

In an example embodiment, the wireless transceiver 406 may be interoperable with various wireless standard/non-standard/proprietary communication networks such as any mobile phone network, regardless of the generation (such as 2G, 3G, 4G, beyond 4G, etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), such as WLAN (Wireless Local Area Network) based on IEEE (Institute of Electrical and Electronics Engineers) 802.11 standard or its evolution versions (IEEE 802.11ac etc.), WiMAX (Worldwide Interoperability for Microwave Access, or Wi-Fi, for example.

In an example embodiment, the wireless transceiver 406, while communicating with a mobile phone network, may require a subscriber identity module (SIM) 420, which may be an integrated circuit storing subscriber data, which is network-specific information used to authenticate and identify subscribers on the cellular network. The subscriber identity module may be embedded into a removable SIM card, on a mini-SIM card, for example. Furthermore, the mobile test reader 100 may include a SIM card reader (not illustrated in FIG. 4), for example. Besides being implemented on a SIM card, the subscriber identity module 420 may be implemented with other techniques as well, such as a virtual/embedded SIM.

In an example embodiment, the mobile test reader 100 includes a RFID reader 408 capable of reading RFID data 214 218 programmed into the electronic tag 204, 208 of the test 102 or its container 210. The reader 408 reads 214, 218 the data from the tag 204, 208 with radio waves. The tag 204, 208 may comprise at least two parts: an integrated circuit for storing and processing information, modulating and demodulating a RF signal, and other specialized functions, and an antenna for receiving and transmitting the signal. The tag 204, 208 may be passive (using no battery), active (with a battery and always broadcasting its signal) or battery assisted passive (with a battery and activated by the presence of the reader 408). In an example embodiment, near field communication (NFC) may be utilized. NFC is a set of standards for smartphones and similar devices to establish radio communication with each other by touching them together or bringing them into close proximity. NFC utilizes various short-range wireless technologies, typically requiring a distance of four centimetres or less. In NFC, the reader 408 is also known as an initiator generating a radio frequency field powering and reading 214, 218 the data from the external object 204, 208 also known as a passive target.

The mobile test reader 100 also comprises one or more processors 410, and one or more memories 418 including computer program code 412.

In an example embodiment, the term ‘processor’ 410 refers to a physical device that is capable of processing data in a computer or other digital electronic device. Depending on the processing power needed, the mobile test reader 100 may comprise several processors 410 such as parallel processors or one or more multicore processors. A non-exhaustive list of implementation techniques for the processor 410 includes, but is not limited to: logic components, standard integrated circuits, application-specific integrated circuits (ASIC), system-on-a-chip (SoC), application-specific standard products (ASSP), microprocessors, digital signal processors, special-purpose computer chips, and field-programmable gate arrays (FPGA).

In an example embodiment, the term ‘memory’ 418 refers to a physical device that is capable of storing the computer program code 412 and data on a temporary or permanent basis for use in a computer or other digital electronic device. In an example embodiment, the term ‘memory’ refers to working memory (also known as primary storage, main memory or internal storage) directly accessible to the processor. In an example embodiment, the working memory may be implemented as a random-access memory (RAM), such as a dynamic RAM, DRAM.

In an example embodiment, the computer program code 412 includes an operating system 414 and application software 416. The operating system may be Android, Microsoft Windows Phone, Apple iOS, Linux, or Symbian, for example. The application software 416 includes all the applications running in the mobile test reader 100.

Naturally, the mobile test reader 100 may include a number of other components, but as they are not required to illustrate the present embodiments, they will not be further described.

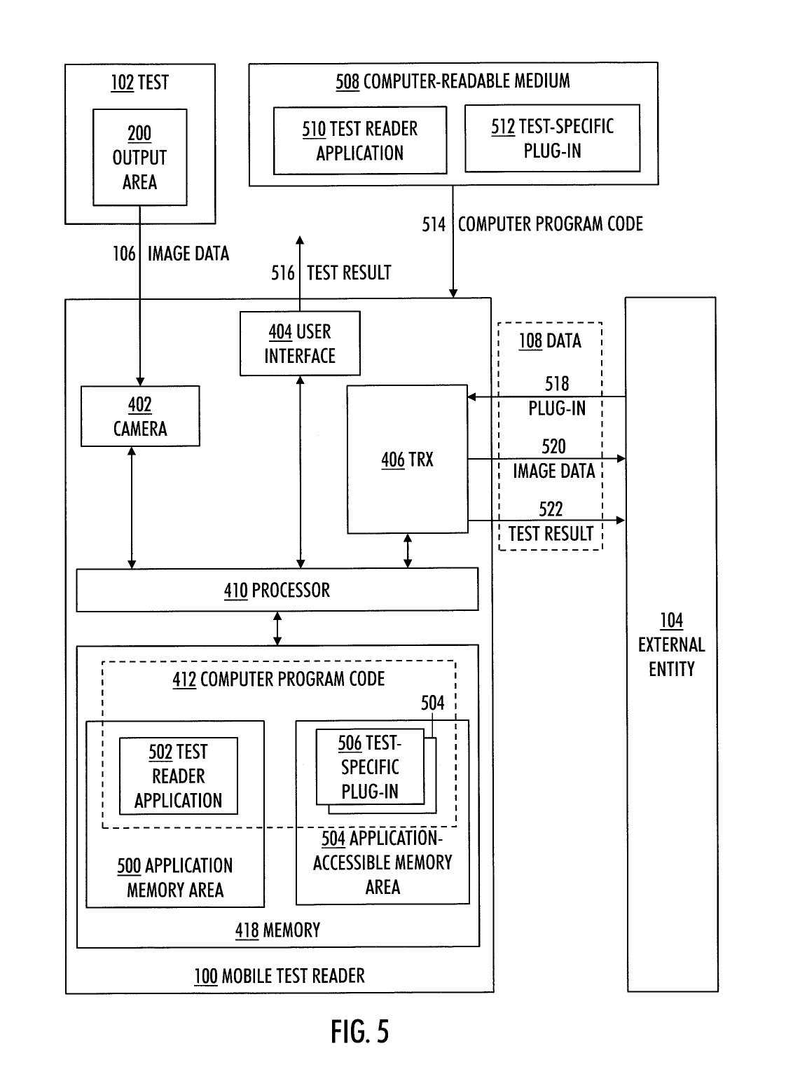

Let us next study FIG. 5, illustrating further example embodiments of the mobile test reader 100, especially the way the mobile test reader 100 interacts with the test 102 and the external entity 104.

The one or more memories 418 and the computer program code 412 are configured to, with the one or more processors 410, cause the mobile test reader 100 to receive, with the wireless transceiver 406, a test-specific plug-in 518 from the external entity 104, to configure a test reader application 502 with the received test-specific plug-in 506, and to take, with the digital camera 402 controlled by the test reader application 502 configured with the test-specific plug-in 506, image data 106 depicting the output area 200 of the test 102.

With this mechanism, the test reader application 502 may be configured with various test-specific plug-ins 506, 504, i.e., the memory 418 may contain different test-specific plug-ins, one for each different type of test 102.

In an example embodiment, the test-specific plug-in 506 comprises at least some of the following information:
an image taking instruction for taking of the image data 106 with the digital camera 402, the image taking instruction comprising at least one of the following: manual/automatic mode, focus distance, location, focus, lighting, shooting angle;
an analysis instruction for analysis of the output area 200, the analysis instruction comprising at least one of the following: optical readability, colour info, ratiometric numbers, a test limit parameter, a test criteria, a test reliability parameter, a test quality parameter, a test validity parameter;
general information on the test 102, the general information comprising at least one of the following: an identifier of a manufacturing batch of the test 102, a manufacturer identifier, a manufacturing date of the test 102, information on the quality of the production batch of the test 102, information on the use by date of the test 102, information on the dimensions or relative dimensions of the output area 200, information on the dimensions or relative dimensions of the test 102.

Naturally, the above described information for the test-specific plug-in 506 is just a non-limiting example embodiment. Furthermore, the following information may or may not be present in the test-specific plug-in: a test 102 identifier, a name for the test 102, a name in the local language(s) for the test 102, an image analysis algorithm, a flashlight instruction (on/off/intensity), a bounding box (=an area within which the output area 200 is searched for), size and location of an aiming crosshair (or box, or other aiming aid) for the output area 200, size of the output area 200 in pixels, a minimum and maximum aspect ratio between the breadth and height of the output area 200, a minimum and maximum intensity of the stripe(s) in the output area 200, location of the stripe(s) in the output area 200, a reliability threshold for successive similar video frames, a maximum allowable deviation for the shooting angle in roll and pitch directions, an offset for said maximum allowable deviation, test 102 interpretation rules, workflow rules for the test 102. The workflow rules for the test 102 may include various information relating to the correct workflow of the testing procedure. The workflow rule may determine that the test 102 result needs to be read after a predetermined time period (5 minutes, for example) from the insertion of the sample in the test 102. The workflow rule may determine when the test result may be shown to the user: immediately, or after a medical doctor or other authority has examined the test 102 result. The workflow rule may determine that other data may need to be collected in order that the medical doctor may make or validate a diagnosis. The workflow rule may determine the nature of the data and timing of the data acquisition. The other data may be collected from the user, before, during, or after making the test 102. These other data may include symptoms (such as general feeling, skin condition) or physiological parameters (such as body temperature) of the user, and such data may be collected through the user interface 404, for example.

The test reader application 502 may include a feedback element, which receives from the external entity 104 a confirmation of the test 102 result, after the medical doctor or other authority has examined the test 102 result. The confirmation may also include a diagnosis, or further information relating to the medical condition of the user. The feedback element may receive the information in pull and/or push fashion from the external entity 104.

The workflow rule may determine the following sequence: scanning of test 102->quick test 102 result generation->transmission of the test 102 to the external entity 104->verification of the test 102 result->feedback to the user->confirmation back to the external entity 104. In this way, the personnel of the external entity 104 may monitor the workflow and, if necessary, also control the workflow: re-taking the test 102, provide interaction between the medical doctor or other authority and the user etc.

Furthermore, the one or more memories 418 and the computer program code 412 are further configured to, with the one or more processors 410, under the control of the test reader application 502 configured with the test-specific plug-in 506, cause the mobile test reader 100 further to perform at least one of the following: transmit, with the wireless transceiver 406, the image data 520 to the external entity 104; generate, with the test reader application 502 configured with the test-specific plug-in 506, a test result for the test 102 on the basis of the image data 106; transmit, with the wireless transceiver 406, the test result 522 to the external entity 104; output, with the user interface 404, the test result 516. This means that the mobile test reader 100 may just transmit the image data 520 to the external entity 104, whereupon the external entity 104 generates the test result. Or it may mean that the test result is generated in the mobile test reader 100, and the test result is shown to the user and/or transmitted to the external entity 104. Even though the test result is generated in the mobile test reader 100, the image data 520 may still be transmitted to the external entity 104 as well.

In an example embodiment, the one or more memories 418 comprises an application memory area 500 and an application-accessible memory area 504. The computer program code of the test reader application 502 may be stored in the application memory area 500. The one or more memories 418 and the computer program code 412 may further be configured to, with the one or more processors 410, cause the mobile test reader 100 to store the received test-specific plug-in 506 in the application-accessible memory area 504.

In an example embodiment, the one or more memories 418 and the computer program code 412 are further configured to, with the one or more processors 410, cause the mobile test reader 100 to store the received test-specific plug-in 506 in the application-accessible memory area 504 without having to exercise any control by an authority other than the user of the mobile test reader 100.

In an example embodiment, the one or more memories 418 and the computer program code 412 are further configured to, with the one or more processors 410, cause the mobile test reader 100 to configure the test reader application 502 with the test-specific plug-in 506 without having to restart the mobile test reader 100 and/or the test reader application 502.

In an example embodiment, the one or more memories 418 and the computer program code 412 are further configured to, with the one or more processors 410, cause the mobile test reader 100 to configure the test reader application 502 with the test-specific plug-in 506 automatically, i.e. without any user interaction, or with the user confirming the operation. Optionally, the user may be informed that the update of the test-specific plug-in 506 has been made.

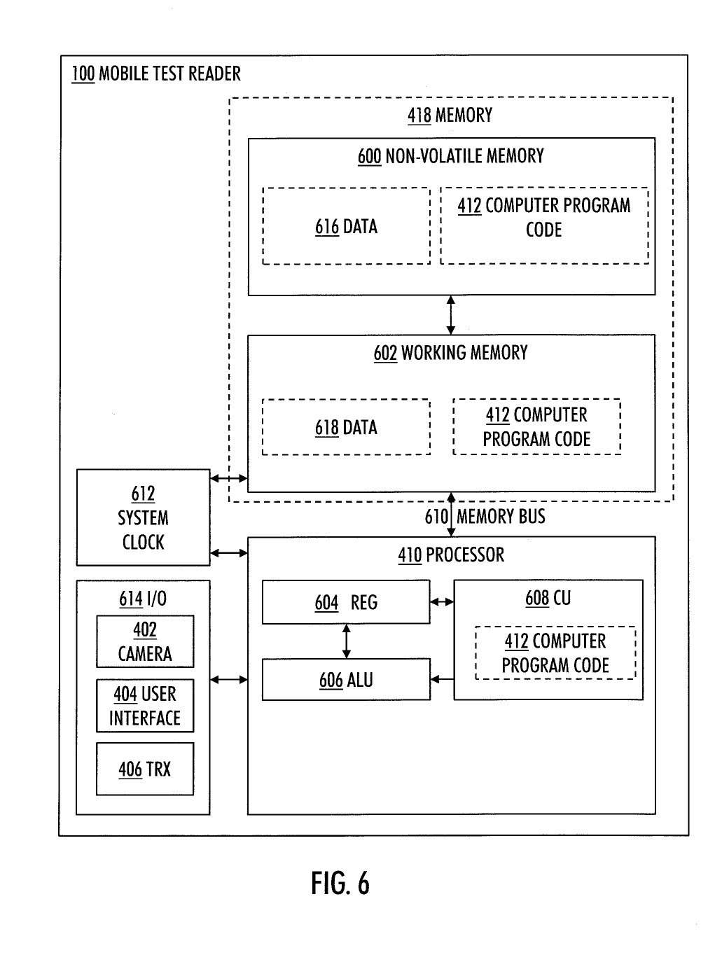

In an example embodiment illustrated in FIG. 6, the mobile test reader 100 may be an electronic digital computer, which may comprise a non-volatile memory 600 and a working memory 602 as the memory 418, the processor 410, a system clock 612 and an input/output 614 including the digital camera 402, the user interface 404, and the wireless transceiver 406. Naturally, the computer may comprise a number of other peripheral devices, not illustrated here for the sake of clarity. Also, the architecture of FIG. 6 is just one example embodiment as other feasible computing architectures may be utilized as well to implement the hardware and software of the mobile test reader 100.

In an example embodiment, the system clock 612 constantly generates a stream of electrical pulses, which cause the various transferring operations within the computer to take place in an orderly manner and with specific timing.

In an example embodiment, the processor 410 may be implemented as a microprocessor implementing functions of a central processing unit (CPU) on an integrated circuit. The CPU 410 is a logic machine executing the computer program code 412. The computer program code 412 may be coded as a computer program using a programming language, which may be a high-level programming language, such as C, C++, or Java, or a low-level programming language, such as a machine language, or an assembler. There are many ways to structure the computer program code 412 In an example embodiment, the operations of the computer program code 412 may be divided into functional modules, sub-routines, methods, classes, objects, applets, macros, etc., depending on the software design methodology and the programming language used. In modern programming environments, there are software libraries, i.e. compilations of ready-made functions, which may be utilized by the computer program code 412 for performing a wide variety of standard operations.

The CPU 410 may comprise a set of registers 604, an arithmetic logic unit (ALU) 606, and a control unit (CU) 608. The control unit 608 is controlled by the computer program code 412 transferred to the CPU 410 from the working memory 602. The working memory 602 is directly or indirectly connected to the CPU 410 via a memory bus 610 including two buses: an address bus and a data bus. The CPU 410 sends a memory address indicating the desired location of data 618 (such as the image data 106, or data 108) or computer program code 412 through the address bus, whereupon the CPU 410 reads or writes the data itself from/to the working memory 602 using the data bus.

The control unit 608 may contain a number of microinstructions for basic operations. The implementation of the microinstructions may vary, depending on the CPU design. The microprocessor 410 may also have an operating system (such as a general-purpose operating system), which may provide the computer program code 412 with system services. During running of the computer program code 412, the computer program code 412 or a part of it are transferred via the memory bus 610 from the working memory 602 into the control unit 608, wherein usually a portion of the computer program code 412 resides and controls the operation.

In an example embodiment, the non-volatile memory 600 retains the stored information even when not powered. Examples of non-volatile memory include read-only memory (ROM), flash memory, magnetic computer storage devices such as hard disk drives, and optical discs. As is shown in FIG. 6, the non-volatile memory 600 may store both data 616 and the computer program code 412.

An example embodiment, illustrated in FIG. 5, provides a computer readable medium 508 comprising the computer program code 412 of the test reader application 510 and the test-specific plug-in 512. Said computer program code 412, when executed on the mobile test reader 100, causes the mobile test reader 100 to perform the operations required to implement the described example embodiments. In an example embodiment, the computer program code 412 may be in source code form, object code form, or in some intermediate form. The computer-readable medium 508 may comprise at least the following: any entity or device capable of carrying 514 computer program code 412 to the mobile test reader 100, a record medium, a computer memory, a read-only memory, an electrical carrier signal, a telecommunications signal, and a software distribution medium. In some jurisdictions, depending on the legislation and the patent practice, the computer-readable medium 508 may not be the telecommunications signal. In an example embodiment, the computer-readable medium 508 may be a non-transitory computer readable storage medium.

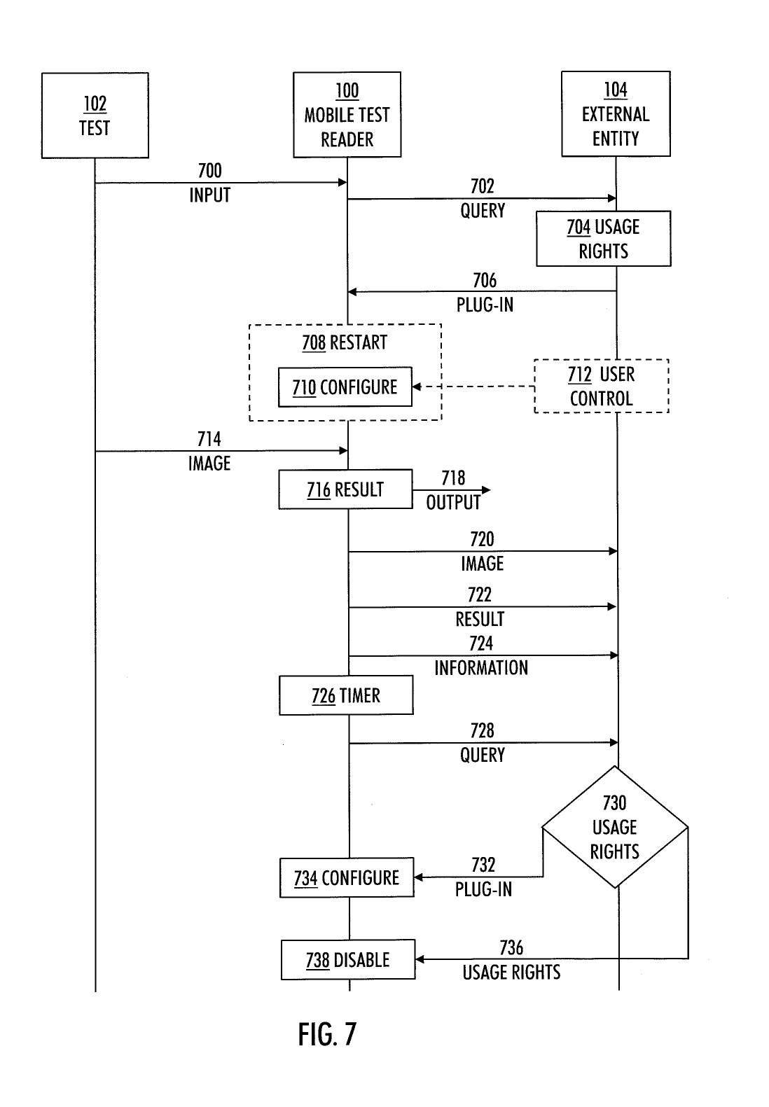

Finally, with reference to FIG. 7, let us study the communication of the mobile test reader 100 and some further example embodiments in the form of a signal sequence chart. Other functions, not described in this application, may also be executed between the operations or within the operations. Some of the operations or parts of the operations may also be left out or replaced by a corresponding operation or part of the operation.

In an example embodiment, the mobile test reader 100 inputs 700, with the digital camera 402 or with the user interface 404, or with a wireless reading (with the RFID reader 408), an identifier of the test 102 and/or type of the test 102 to the test reader application 502.

In an example embodiment, the mobile test reader 100, prior to receiving the test-specific plug-in 506 from the external entity 104, transmits 702, with the wireless transceiver 406, a query to the external entity 104 regarding the test-specific plug-in 506, the query including the present status of the test-specific plug-in 506, the present status indicating the presence of the test-specific plug-in 506, and/or or the version number of the test-specific plug-in 506. If the test-specific plug-in 506 is present, the version number may be transmitted, but if the test-specific plug-in is missing, only the presence information may be transmitted.

In an example embodiment, the mobile test reader 100 transmits, with the wireless transceiver 406, information relating to the mobile test reader 100 to the external entity 104, the information relating to the mobile test reader 100 including at least one of the following: type of the mobile test reader 100, location of the mobile test reader 100, local time of the mobile test reader 100, information on the climatic conditions surrounding the mobile test reader 100.

As illustrated in FIG. 4, in order to determine its location, the mobile test reader 100 may comprise a positioning receiver 424 receiving external location information, which may be utilized to generate location of the mobile test reader 100. The positioning receiver 424 may be a receiver of a global navigation satellite system (GNSS). Such a system may be the Global Positioning System (GPS), the Global Navigation Satellite System (GLONASS), the Galileo Positioning System (Galileo), the Beidou Navigation System, The Quasi-Zenith Satellite System (QZSS), or the Indian Regional Navigational Satellite System (IRNSS), for example. The positioning receiver 424 determines its location (longitude, latitude, and altitude) using signals transmitted from satellites orbiting the earth. Besides global navigation satellites, the positioning receiver 424 may also determine its location by utilizing other known positioning techniques. It is well known that by receiving radio signals from several different base stations, a mobile phone may determine its location, for example.

FIG. 7 also illustrates the earlier described basic sequence: the mobile test reader 100 receives 706, with the wireless transceiver 406, the test-specific plug-in 518 from the external entity 104, configures 710 the test reader application 502 with the received test-specific plug-in 506, and takes 714, with the digital camera 402 controlled by the test reader application 502 configured with the test-specific plug-in 506, image data 106 depicting the output area 200 of the test 102.

It is to be noted, as was explained earlier, that in an example embodiment the mobile test reader 100 stores the received test-specific plug-in 506 in the application-accessible memory area 504 without having to exercise any control 712 by an authority other than the user of the mobile test reader 100. The mobile test reader 100 also configures in an example embodiment the test reader application 502 with the test-specific plug-in 506 without having to restart 708 the mobile test reader 100 and/or the test reader application 502. Accordingly, reference numerals 708 and 712 depict such operations that are not required at all in certain example embodiments.

The earlier described basic sequence continues in FIG. 7 as follows: the mobile test reader 100, under the control of the test reader application 502 configured with the test-specific plug-in 506, performs at least one of the following: transmits 720, with the wireless transceiver 406, the image data 520 to the external entity 104; generates 716, with the test reader application 502 configured with the test-specific plug-in 506, a test result for the test 102 on the basis of the image data 106; transmits 722, with the wireless transceiver 406, the test result 522 to the external entity 104; outputs 718, with the user interface 404, the test result 516. As was explained earlier, also other information 724 may be transmitted from the mobile test reader 100 to the external entity 104.

In an example embodiment, the mobile test reader 100 receives 706, with the wireless transceiver 406, the newest version of the test-specific plug-in 506, and configures 710 the test reader application 502 with the newest version of the test-specific plug-in 506.

The configuring of the test reader application 502 with the test-specific plug-in 506 may be performed as required. When the mobile test reader 100 prepares for reading the test 102, it queries 702 the external entity for the test-specific plug-in 506, either for the first time, or for the latest version. FIG. 7 also illustrates another example embodiment, the mobile test reader 100 may include a timer mechanism 726, with which the mobile test reader 100 is able to query for the newest version of the test-specific plug-in at predetermined intervals (every five minutes, for example) or at predetermined times (once a day or week at noon, for example). The external entity 104 may also transmit the test-specific plug-in 506 to the mobile test reader 100 without any stimulus received from the mobile test reader 100, with a push mechanism, for example.

In an example embodiment, the mobile test reader 100 manages, with the test reader application 502 the usage rights 704, 730 of the test 102 such that the test-specific plug-in 506 is removed if no usage rights exist for the test 102 on the basis of information received from the external entity 104 with the wireless transceiver 406.

In an example embodiment, the mobile test reader 100 transmits 728, with the wireless transceiver 406, hardware identifier of the mobile test reader 100 and/or user account information of the user of the mobile test reader 100 to the external entity 104, and receives 732/736, with the wireless transceiver 406, usage rights of the test-specific plug-ins 506, 504.

In an example embodiment, the external entity 104 keeps 730 track of the usage rights of the test 102, whereby, if the usage rights exists, the external entity 104 transmits 732 the test-specific plug-in to the mobile test reader 100, whereupon the mobile test reader 100 configures 734 the test reader application 502 with the test-specific plug-in 506, or, if the usage rights do not exist, the external entity 104 only transmits 738 usage rights information to the mobile test reader 100, whereupon the mobile test reader 100 disables 738 the test-specific plug-in 506, if such is present in the mobile test reader 100. The disable-function 738 may just make the test-specific plug-in 506 inoperable, or it may remove the test-specific plug-in 506 altogether.

In an example embodiment, the mobile test reader 100 calculates a check-sum for the present test-specific plug-ins 506, 504, and the check-sum is transmitted to the external entity 104. The external entity 104 maintains an account for each mobile test reader 100, i.e. usage rights of each mobile test reader 100 for the test-specific plug-ins 506, 504. If the check-sum that is in the account matches with the check-sum that is received from the mobile test reader 100, the external entity 104 determines that no update is required. However, if the check-sums do not match, the external entity 104 initiates the required operations as regards to the usage rights: either a new plug-in is transmitted to the mobile test reader 100, some or all plug-ins are updated, or one or more plug-ins are made inoperable or even removed from the mobile test reader 100, for example.

It will be obvious to a person skilled in the art that, as technology advances, the inventive concept can be implemented in various ways. The invention and its embodiments are not limited to the example embodiments described above but may vary within the scope of the claims.

1. A mobile test reader apparatus comprising
a digital camera,
a wireless transceiver,
a user interface,
one or more processors, and
one or more memories including computer program code,
the one or more memories and the computer program code configured to, with the one or more processors, cause the mobile test reader apparatus at least to perform:
receive, with the wireless transceiver, a test-specific plug-in from an external entity;
configure a test reader application with the test-specific plug-in; and
take, with the digital camera controlled by the test reader application configured with the test-specific plug-in, image data depicting an output area of a test;
and, the one or more memories and the computer program code are further configured to, with the one or more processors, under the control of the test reader application configured with the test-specific plug-in, cause the mobile test reader apparatus further to perform at least one of the following:
transmit, with the wireless transceiver, the image data to an external entity;
generate, with the test reader application configured with the test-specific plug-in, a test result for the test on the basis of the image data;
transmit, with the wireless transceiver, the test result to an external entity;
output, with the user interface, the test result.

2. The mobile test reader apparatus of claim 1, wherein the test comprises at least one of the following: a lateral flow test, a test of at least one such chemical property that affects the visual appearance of the output area.

3. The mobile test reader apparatus of claim 1, wherein the external entity comprises at least one of the following: a manufacturer of the mobile test reader apparatus, a distributor of the mobile test reader apparatus, a manufacturer of the test, a distributor of the test, a health-care organization, a service provider, a server, a cloud computing.

4. The mobile test reader apparatus of claim 1, wherein the mobile test reader apparatus comprises at least one of the following: a mobile phone, a smartphone, a tablet computer, a general-purpose mobile computing device.

5. The mobile test reader apparatus of claim 1, wherein the test-specific plug-in comprises at least some of the following information:
an image taking instruction for taking of the image data with the digital camera, the image taking instruction comprising at least one of the following: manual/automatic mode, focus distance, location, focus, lighting, shooting angle;
an analysis instruction for analysis of the output area, the analysis instruction comprising at least one of the following: optical readability, colour info, ratiometric numbers, a test limit parameter, a test criteria, a test reliability parameter, a test quality parameter, a test validity parameter;
general information on the test, the general information comprising at least one of the following: an identifier of a manufacturing batch of the test, a manufacturer identifier, a manufacturing date of the test, information on the quality of the production batch of the test, information on the use by date of the test, information on the dimensions or relative dimensions of the output area, information on the dimensions or relative dimensions of the test.

6. The mobile test reader apparatus of claim 1, wherein the one or more memories comprises an application memory area and an application-accessible memory area, and the computer program code of the test reader application is stored in the application memory area, and wherein the one or more memories and the computer program code are further configured to, with the one or more processors, cause the mobile test reader apparatus further to perform:
store the received test-specific plug-in in the application-accessible memory area.

7. The mobile test reader apparatus of claim 6, wherein the one or more memories and the computer program code are further configured to, with the one or more processors, cause the mobile test reader apparatus further to perform:
store the received test-specific plug-in in the application-accessible memory area without having to exercise any control by an authority other than the user of the mobile test reader apparatus.

8. The mobile test reader apparatus of claim 1, wherein the one or more memories and the computer program code are further configured to, with the one or more processors, cause the mobile test reader apparatus further to perform:
configure the test reader application with the test-specific plug-in without having to restart the mobile test reader apparatus and/or the test reader application.

9. The mobile test reader apparatus of claim 1, wherein the one or more memories and the computer program code are further configured to, with the one or more processors, cause the mobile test reader apparatus further to perform:
input, with the digital camera or with the user interface, or with a wireless reading, an identifier of the test and/or type of the test to the test reader application.

10. The mobile test reader apparatus of claim 1, wherein the one or more memories and the computer program code are further configured to, with the one or more processors, cause the mobile test reader apparatus further to perform:
prior to receiving the test-specific plug-in from the external entity, transmit, with the wireless transceiver, a query to the external entity regarding the test-specific plug-in, the query including the present status of the test-specific plug-in, the present status indicating the presence of the test-specific plug-in, and/or or the version number of the test-specific plug-in.

11. The mobile test reader apparatus of claim 1, wherein the one or more memories and the computer program code are further configured to, with the one or more processors, cause the mobile test reader apparatus further to perform:
transmit, with the wireless transceiver, information relating to the mobile test reader apparatus to the external entity, the information relating to the mobile test reader apparatus including at least one of the following: type of the mobile test reader apparatus, location of the mobile test reader apparatus, local time of the mobile test reader apparatus, information on the climatic conditions surrounding the mobile test reader apparatus.

12. The mobile test reader apparatus of claim 1, wherein the one or more memories and the computer program code are further configured to, with the one or more processors, cause the mobile test reader apparatus further to perform:
receive, with the wireless transceiver, the newest version of the test-specific plug-in; and
configure the test reader application with the newest version of the test-specific plug-in.

13. The mobile test reader apparatus of claim 1, wherein the one or more memories and the computer program code are further configured to, with the one or more processors, cause the mobile test reader apparatus further to perform:
manage, with the test reader application the usage rights of the test such that the test-specific plug-in is removed if no usage rights exist for the test on the basis of information received from the external entity with the wireless transceiver.

14. The mobile test reader apparatus of claim 1, wherein the one or more memories and the computer program code are further configured to, with the one or more processors, cause the mobile test reader apparatus further to perform:
transmit, with the wireless transceiver, hardware identifier of the mobile test reader apparatus and/or user account information of the user of the mobile test reader apparatus to the external entity; and
receive, with the wireless transceiver, usage rights of the test-specific plug-ins.

15. A computer-readable non-transitory medium comprising computer program code of a test reader application and a test-specific plug-in, which computer program code, when executed on a mobile test reader apparatus, causes the mobile test reader apparatus to:
receive, with a wireless transceiver, a test-specific plug-in from an external entity;
configure a test reader application with the test-specific plug-in; and
take, with a digital camera controlled by the test reader application configured with the test-specific plug-in, image data depicting an output area of a test;
and at least one of the following:
transmit, with the wireless transceiver, the image data to an external entity;
generate, with the test reader application configured with the test-specific plug-in, a test result for the test on the basis of the image data;
transmit, with the wireless transceiver, the test result to an external entity;
output, with the user interface, the test result.
